(19) United States
(12) Patent Application Publication
(10) Pub. No.: US 2017/0257912 A1
(43) Pub. Date: Sep. 7, 2017

(54) MAGNETIC INDUCTION HEATING WITH SPACER

(71) Applicant: Adventys, Seurre (FR)

(72) Inventor: Jean-Emmanuel Maisert, Chamboeuf (FR)

(73) Assignee: Adventys, Seurre (FR)

(21) Appl. No.: 15/443,756

(22) Filed: Feb. 27, 2017

(30) Foreign Application Priority Data
Mar. 1, 2016 (EP) 16305236.8

(51) Int. Cl. H05B 6/06; A47J 36/24; H05B 6/12

(52) U.S. Cl. CPC H05B 6/062; H05B 6/1209; A47J 36/24; H05B 2213/04; H05B 2213/07

(57) ABSTRACT

A device for heating an object adapted to be heated by magnetic induction and comprising a thermally insulating spacer to be placed between the heat-retaining object and a support. The device also includes a control and induction heating unit, which includes an inductor, a temperature sensor for detecting the temperature of the support, and an inductor control unit connected to the temperature sensor for controlling the inductor, such that the electromagnetic field is induced according to the readings from the sensor. The inductor control unit limits the magnitude of the electromagnetic field when the detected temperature reaches a predetermined threshold lower than a degradation temperature of the support.

### BACKGROUND OF THE INVENTION

This invention relates to the field of heating a heat-retaining object by magnetic induction.

In particular, it concerns a device for heating such an object used to itself heat, or keep warm, a food product.

From U.S. 2011/0089162 and/or U.S. Pat. No. 8,344,296, such a device is already known comprising:

a heat-insulating spacer interposed between the heat-retaining object and a support to limit an amount of heat transfer from the heat-retaining object toward the support (such as thermal conduction between said object and the support),

a control and induction heating unit located under the support and comprising:
a heating device adapted to create an electromagnetic field around the heat-retaining object, and
an inductor.

In U.S. 2011/0089162, the device further comprises:

an LWMC emitter carried by the thermally insulating spacer to transmit information relating to one or more parameters specific to the object to be heated,

and an LWMC receiver associated with the heating device so that the latter takes account of the parameters transmitted.

In U.S. 2011/0089162, the device further comprises an RFID tag carried by the spacer and capable of communicating with an RFID reader associated with the heating device.

As the disadvantages of these solutions, we can note:

the need to know the temperature of the heat-retaining object (or object to be heated) in order to be able to regulate the temperature,

the consequent need to have either a suitable element for receiving the temperature probe or a device which must remain in physical contact with the object to be heated,

the need to add an electronic transmitter/receiver device,

the presence of this equipment in the spacer, while the latter is subjected to thermal fluxes which may be large,

the addition of LWMC- or RFID-compatible processing electronics,

the consequent difficulty of rapidly and cheaply equipping the equipment already in service,

the fact that the heat-retaining object, or object to be heated, must not overlap the transmitter/receiver electronic device, otherwise the communication cannot be established,

the precise positioning requirement of the electronic device: the transmitter and the receiver must be facing each other,

a requirement of flatness between the base of the heat-retaining object and the temperature sensor, in order to ensure good measurement quality and therefore good temperature control.

### SUMMARY OF THE INVENTION

The object of the invention is to overcome at least some of these disadvantages and aims to prevent the support from being degraded if it is overheated, typically from being cracked under thermal stress.

To this end, the invention proposes that the above-mentioned means of the device specific to U.S. 2011/0089162 and/or U.S. Pat. No. 8,344,296 be replaced in some way, on the control and induction heating unit, by:

a temperature sensor located under the support for detecting the temperature of the support,

means for controlling the inductor connected to the temperature sensor, such that the electromagnetic field is induced according to the readings of the temperature sensor,

and means to limit the energy transmitted by the inductor which act on the control means of this inductor in order to limit the magnitude (intensity) of said electromagnetic field induced when the detected temperature reaches a predetermined threshold lower than a degradation temperature of the support.

Thus, it is directly the temperature of the support that will be detected, without need for the above-mentioned electronics on the spacer, and it will be possible simply to secure the temperature behaviour of the support in order to prevent it from deteriorating, by controlling the intensity of the induced electromagnetic field at the detected temperature of the support, with the setting of a threshold.

In practice, in addition to having a thermal conductivity lower than that of the support (e.g. by being thermally insulating), the spacer will advantageously have a shape that allows natural convection and thermal radiation to pass through the support. A generally annular shape will be appropriate.

Furthermore, it has been found that, since the support acts as an energy storage unit, its temperature tends towards the temperature of the heat-retaining object in the very long term, and, since the means of limiting the magnetic field prevent the support exceeding a critical threshold temperature, the temperature of the heat-retaining object could, in certain situations, fall to a level much lower than the minimum level for keeping it warm.

In order to solve this problem, it is proposed that, in addition to the above-mentioned means, the device should comprise cooling means which will cool the support by establishing a temperature difference between the top and base of this support, at least in the environment of the temperature sensor, during at least a portion of the magnetic induction heating of the heat-retaining object.

By thus extracting an amount of heat from the support, a temperature difference between the heat-retaining object and the support will be favoured, and the temperature sensor will thus detect a temperature lower than the permissible threshold temperature of this support, thus being able to continue not to limit the induced electromagnetic field ensuring the heating of the heat-retaining object.

A problem related to this solution then arises, related to the means to be used for ensuring this extraction of a certain amount of heat from the support during the heating of the heat-retaining object.

It is now proposed that these means for cooling the support be located under the support, in the environment of the control and inductive heating unit, in order to further contribute to the thermal regulation of the electronic components of the inductor or the means for controlling the inductor.

Indeed, it will thus be possible to obtain a double effect, without making the cooling means put in place visible or inconvenient.

In terms of a practical solution, it will be possible in particular to envisage using, for these cooling means of the support, at least one fan, and preferably two fans side by side, which are not visible from the top of this support.

It has been found in the tests conducted that, since the heat-retaining object is conventionally heated by the inductive effect, the thermal flux then transmitted by the natural convection and radiation of this heat-retaining object towards the support in fact heated the support rather slowly. If, as anticipated, the material of the support shows good thermal conduction (λ>0.1 W/m·K), its thickness (preferably 4 to 40 mm) will give it high thermal inertia. There is therefore a risk of an excessively high temperature rise in the heat-retaining object.

One solution to this problem proposes that the inductor be controlled to deliver its energy according to at least one predetermined temperature rise gradient.

Moreover, in practice, it is advisable that this (at least one) predetermined temperature rise gradient is lower than 0.04° C. per second, and preferably includes a first gradient of lower than 0.04° C. per second, then a second still lower gradient, for the last 5 to 10° C. prior to reaching said predetermined threshold lower than the degradation temperature of the support (limiting set point).

Yet another solution proposes the use, as a temperature sensor, of a sensor that is sensitive to the magnetic field generated. Indeed, when subjected to such a magnetic field, this sensor will then heat up in a manner similar to the temperature change of the heat-retaining object.

This solution will be all the more advantageous if the device comprising the means for limiting the electromagnetic field also limits the rate of temperature variation of the sensor very slowly, thus limiting the rate of rise in temperature of the heat-retaining object while the support increases in temperature and reaches the imposed limiting set point. This will reduce the heating time of the heat-retaining object while preventing the excessive heating of the support.

Advantageously, in order to achieve a reasonable balance between the time required for sufficient heating of the heat-retaining object, e.g. to heat the water of a cooking appliance to about 80-90° C. by a chafing-dish, and for the cooling of the base of the support, it is further proposed that the support be a work surface:

made of stone or concrete,

and/or made of a material permeable to magnetic fields having good thermal conductivity (λ>0.1 W/m·K).

Including in this application for a cooking appliance for heating by a chafing-dish, the heat-retaining object will advantageously comprise either the food container itself provided with a plate sensitive to the electromagnetic field to transform it into heat, or only a ferromagnetic block, e.g. a disc to be placed in contact, under a tank of the cooking appliance in question.

The spacer will preferably comprise a hollow cushion, made e.g. of silicone, to be interposed between the heat-retaining object and the support, thus having a shape favouring the passage of natural convection and heat radiation towards the support through the central opening.

In addition to the device just presented, the invention relates to a method for heating said heat-retaining object, said method comprising known steps wherein:

a spacer is interposed between the heat-retaining object and a support underneath, whereby the spacer has a thermal conductivity lower than that of the support,

an inductor placed under the support creates an electromagnetic field around the heat-retaining object, whereby the spacer then limits an amount of heat transfer (thermal conductivity) from the heat-retaining object to the support, but allows a heat transfer by thermal radiation and natural convection towards this support,

during such induction heating, the temperature of the support is detected by a temperature sensor,

the inductor is controlled such that the electromagnetic field is induced according to the readings of the temperature sensor and a setpoint set by the user, by limiting the magnitude (intensity) of the electromagnetic field induced when the temperature detected reaches a predetermined threshold lower than a degradation temperature of the support.

The advantages already expressed for the device are reproduced here.

Preferably, during at least a portion of the magnetic induction heating of the heat-retaining object, the support is cooled, at least in the environment of the temperature sensor placed under the support, such that the temperature at the lower face of the support is then lower than the temperature on the upper face of the support.

Moreover, preferably, as already expressed for the device:

under the support and in the environment of the inductor, it may be desired to have means for cooling the support, such that they also participate in the thermal regulation of the electronic components of the inductor,

and/or the support is cooled by means of at least one fan during the entire induction heating of the heat-retaining object.

In this respect, performing this localised cooling of the base of the support by this fan or these fans will allow, in a simple, fast, space-saving, reliable and energy-saving way, the creation of forced convection under the support and thus the extraction of an effective amount of heat from it.

Advantageously, in order to heat the object in question sufficiently while preserving the support, it is advisable that, during the induction heating of the heat-retaining object, a temperature difference of between 20° and 50° C., and preferably between 35° C. and 45° C., is established between this object and the support.

The regulation will advantageously be programmed in advance on this basis, such that the energy delivered is adjusted accordingly over time.

Concerning the conditions in which the temperature increases are performed for both the object in question and the support, such that the first one is both sufficient and sufficiently fast and the second one is sufficiently low as not to degrade the integrity of this support, it should also be noted that it will furthermore be considered useful for the inductor to be controlled to deliver its energy according to (at least) one predetermined temperature rise gradient thus serving as a setpoint.

In terms of the setpoint(s), it will thus be possible, in particular, to provide for a user-defined setpoint set with a control keypad connected to said control means and/or that provided by said energy-limiting means transmitted by the inductor, whereby this latter setpoint can, in particular, be linked to a maximum temperature not to be exceeded and/or to its equivalent in energy to be delivered and/or to a maximum speed of variation of the temperature recorded by the temperature sensor placed to detect the temperature of the support.

In practice, if such a choice is used to take into account a predetermined pair of temperature rise gradient/other setpoint(s), it will, in particular, be possible in addition to select that said gradient be lower than 0.04° C. per second, and preferably comprising a first gradient of lower than 0.04° C. per second, and then a second gradient which is still lower, for the last 5-10° C. before the limiting setpoint (predetermined temperature threshold lower than the degradation temperature of the support).

Thus, we will be far from the usual temperature rise, which is faster, on conventional magnetic induction heating devices.

It has been seen above that, with a temperature sensor of the support sensitive to magnetic fields, the field created by the inductor will result in a slight rise in the temperature detected by said sensor. Since this rate of temperature variation of the sensor can be of the same order of magnitude as that of the ferromagnetic heating plate of the heat-retaining object, the higher the power of the field, the faster the rate of temperature variation of the sensor and this plate.

It is therefore proposed:

based on the temperature readings of said temperature sensor, to deduce a rate of variation of the detected temperatures,

to limit the magnitude (intensity) of the electromagnetic field induced when said rate of variation in temperature is greater than a predetermined threshold.

### BRIEF DESCRIPTION OF THE DRAWINGS

The above and other characteristics are further detailed in the following description made with reference to the drawings, only by way of example, in which:

FIG. 1 is an example of furniture according to the invention,

FIG. 2 shows schematically an operational circuit of the device as imagined,

FIG. 3 is a vertical sectional view that complements the presentation of a possible function in operation of the device,

FIG. 4 shows schematically the energy flows involved,

FIG. 5 is a vertical sectional view of an alternative embodiment of the inductive base, in this case a separate tablet placed under the base of the container to be heated or kept warm,

and FIGS. 6,7 illustrate the temperature curves (in ° C./s).

### DETAILED DESCRIPTION OF THE PREFERRED EMBODIMENTS

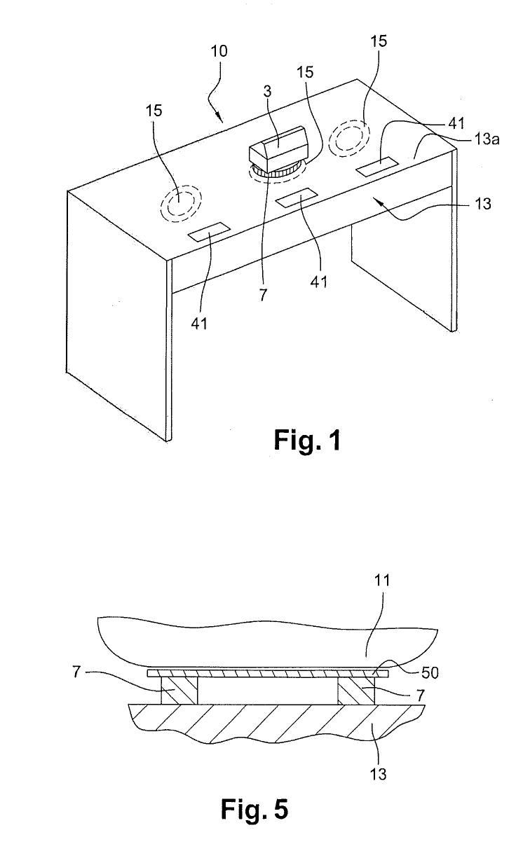

Referring first to FIG. 1, it shows schematically an induction table for heating an object 3 by electromagnetic induction.

As is known, this heating method uses the electromagnetic properties of certain materials which, when subjected to an alternating field, allow induced currents (eddy currents) to be developed.

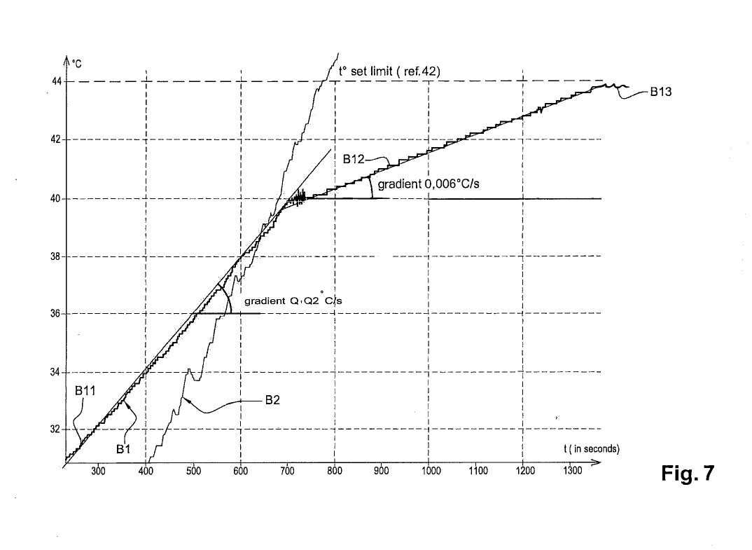

In addition, the object to be heated 3 is provided either with a ferromagnetic base 5 (FIG. 1), or a ferromagnetic disc 50 is placed in contact with it (FIG. 5), between it and a spacer 7, which will be discussed hereinafter.

The object to be heated 3 is made of a thermally conductive material, to favour, by its own heating, the heating or keeping warm of a food product 9 placed inside it.

The object to be heated 3 can, in particular, be a metallic appliance (chafing-dish) suitable for heating up to 80-90° C. an amount of water contained in its tank 11 having a ferromagnetic base 5 in the example of FIG. 1.

For its use, the object to be heated 3 is placed above a support 13, with interposition of the spacer 7.

The material of the support will be permeable to the generated magnetic field and thermally conductive.

The spacer 7 could be integrated into the base of the object 3, in the manner of a structure projecting downwards, or even hypothetically at the upper surface 13a of the support 13, in the manner of a structure projecting upwards.

The term “interposed” covers these various cases, such as the one in which, in the preferred example used, it is a separate element adapted to be placed or fitted stably between the base of the object to be heated 3 and the support 13, which here is a flat support. This spacer has a lower thermal conductivity than the support.

The support 13 may be a table or a tray, for example, advantageously adapted to create a working surface, thus integrating at least one induction heating zone. However, at least with such heating of the cooking appliance in question, this support 13 is at risk of having hot spots created due to the energy to be induced to sufficiently heat the water in the chafing-dish. This may result in degradation of the support, which may cause it to crack.

Since the presence of the spacer 7 and certain features further developed hereinafter prevent this, it will be possible for the support 13 to remain advantageously in a material permeable to magnetic fields with a good thermal conductivity (λ>0.1 W/m·K), preferably with a thickness of between 4 mm and 40 mm.

This spacer 7 and the following components belong to the inductive heating device 10, said components being considered to belong to a control and heating unit 20 which, in addition to a temperature sensor 35 connected (i.e. communicating with) the means or unit 31 for controlling the inductor (to which it transmits its readings), comprises a heating device comprising an electronic power unit 30 connected to an inductor 15.

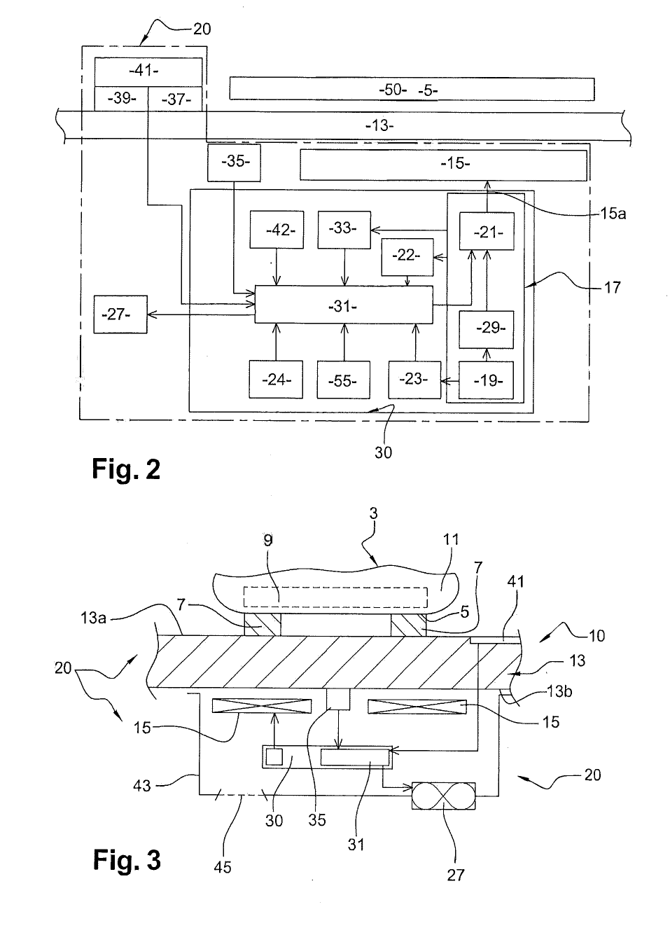

The magnetic field through which the object 3 placed on the support 13 can be heated is obtained by an induction coil 15 (FIG. 2 in particular) supplied with a high-frequency alternating current 15a.

The coil 15 (also called an inductor) is controlled by a power card 17 which converts the frequency of the network (mains power 19; e.g. 230V, 50 Hz) to a higher frequency, e.g. 20 to 50 kHz (high-frequency alternating current 15a).

This signal is obtained by an inverter 21 which recreates this high-frequency alternating current after rectification by a bridge rectifier 29. The current is regulated by acting on the frequency of the signal transmitted to the coil 15 by the inverter 21 controlled by the control unit 31.

The ferromagnetic base of the object to be heated 3 (base 5 or tablet 50) subjected to the alternating magnetic field generates induced currents (eddy currents) which heat the container.

The control unit 31 is powered by the low-power power supply 23 which is itself powered by the bridge rectifier 29.

Also, connected to the control unit 31, and supplying it with useful data for regulation, there is a safety device 33 (safety of over-voltage, presence of an object with a ferromagnetic zone, over-consumption, etc.), the temperature sensor 35 of the support 13, a temperature sensor 24 of the unit 31, a power measurement unit 22, memory means 42 (containing at least limiting parameters, or set points, not to be exceeded) and a user panel 41 accessible to the latter (on the top 13a).

The user panel 41 comprises displays 37 and a control keypad 39 on which the user can act in order to adapt to some extent, at his convenience, the heating of the appliance 3 placed on the spacer 7.

As the setpoint data available in the memory means 42 for the control unit 31, it is possible to provide, in combination or not, and not to be exceeded, a maximum temperature (of the support 13) that can be detected by the sensor 35, a maximum energy or power to be delivered by the inductor 15, a maximum temperature variation rate detected by the sensor 35, another maximum setpoint temperature, such that the magnetic field created via the inductor, or, more generally, the energy transmitted by this device to the object 3, is adapted such that the support 13 is not degraded.

In direct relation with the power unit 17, a power measurement unit 22 calculates, in real time, the active power consumed by the ferromagnetic base of the object to be heated 3 (base 5 or plate 50).

Thus, the control means 31 will define a calculation and control unit which, according to input data (derived in particular from the temperature sensor 35, the setpoint values 42 previously entered in the memory, and from the keypad 39), and will control, in addition therefore to the inverter 21, the means 27 which advantageously allow the base 13b of the support to be brought to a temperature lower than that of its top 13a.

Moreover, it will be understood that all or part of these instructions, provided to the unit or card 31 and its servo-control program, that will thus serve as means for limiting the energy transmitted, and therefore the electromagnetic field, when the temperatures rise and, in particular, reach a threshold (e.g. at 5° C.) close to the degradation temperature of the support 13.

The means 27 for cooling this support may comprise one or more fans.

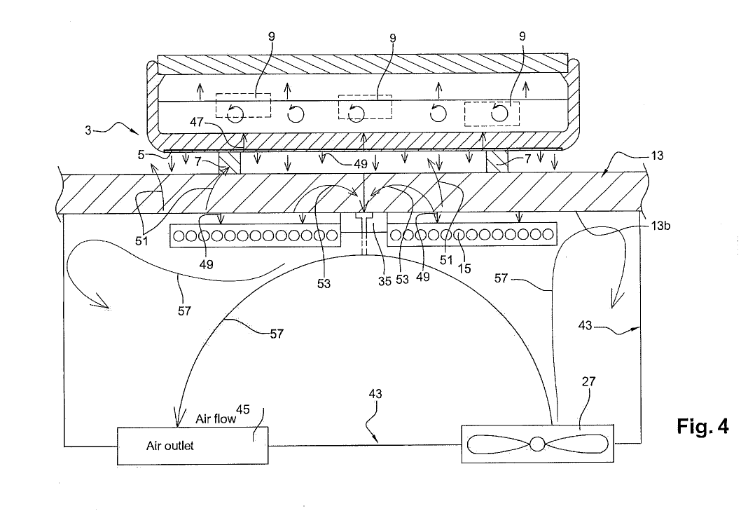

As can also be seen in FIG. 3, the temperature sensor 35, arranged to detect the temperature of the support 13, is located in the environment of the fan(s) 27 arranged under the support 13, in order to cool it. In addition, each fan 27 may advantageously be located in the immediate vicinity of the induction components of the card 31 and the electronic power unit 30, in order to also contribute to their cooling, if necessary.

With the (or each) fan 27 placed under the control of the control card 31, the flow of cooling air emerging therefrom will be adapted according to the temperature of the support 13 detected by the sensor 35, e.g. by variation of the speed of rotation of the blades of the (of each) fan, and typically such that this speed is higher if the detected temperature increases, or by taking into account the ambient temperature detected by a sensor 55.

In particular, the fan(s), e.g. two in number, may be arranged at the inlet of a closed chamber 43 provided with an air outlet 45 and fixed under the support 13. The chamber 43 will, in particular, contain the elements 15, 30, 31, 35.

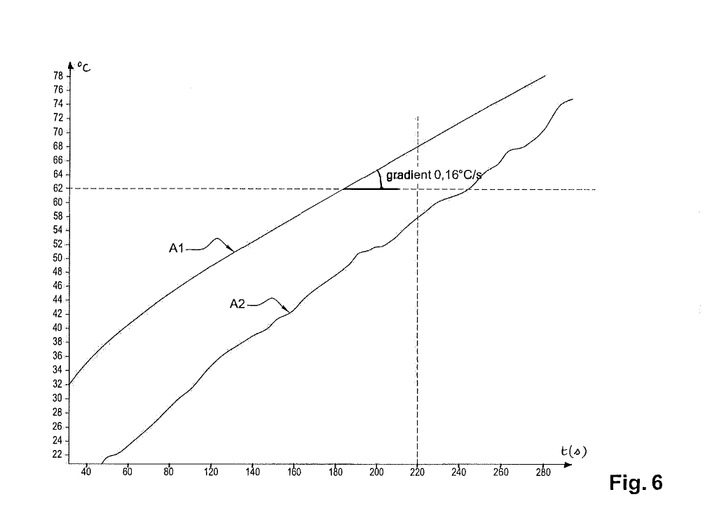

The inside of the closed chamber 43 is swept by the fluid flow 57 generated by the means 27 for cooling the support, such that its base 13b effectively receives this flow (FIG. 4).

To be able to ensure the heating, even in a keeping warm situation, of an induction-compatible object, such as the container 3, the temperature of the container must be known in order to be able to regulate this temperature and thus make it stable.

The solution presented here makes it possible to dispense with a direct measurement of the temperature of this container, as provided for in the prior art, and thus releases the constraint of a material related to the shapes and sizes of the object 3.

Indeed, with this solution and as shown schematically in FIG. 4, when the ferromagnetic zone of the object 3 receives the magnetic field generated by the inductor 15, this field will induce not only a first thermal flux 47 transmitted by thermal and natural conduction to the food products 9, but also a second thermal flux 49 transmitted towards the support 13, via thermal radiation and natural thermal convection, whereby the direct thermal conduction is suppressed, or notably reduced, by the spacer 7, which can be thermally insulating.

Thus, according to Fourier's law, the higher the temperature of the object 3, the higher the thermal fluxes will be. After a certain time, the temperature of the top of the support 13 will therefore tend to become the image of the temperature of the object 3 (or its ferromagnetic base), whereby the support 13 behaves like an energy storage unit (substantially in the manner of a mass stove or a capacitor charge in electronics).

By virtue of the spacer 7, the temperature of the top 13a of the object 3 will therefore be able to remain appreciably lower than the temperature of this object (or its ferromagnetic base).

Transmitted by thermal conduction to below the support 13, it is this “limited” temperature that is detected by the temperature sensor 35, according to which data the control of the heating is managed.

Via the control card 31, the control and heating unit 20 will then regulate the temperature which receives this data from the object 3, thus indirectly by using the phenomena of convection and thermal radiation as a mode of wireless transmission, without the need for an LWMC or RFID connection. Since the heat propagation times are typically quite long, the control will be regulated advantageously according to this parameter and to limit the rapid temperature variations detected by the sensor 35 in order to prevent overheating.

A disadvantage of this principle may, however, be that the difference between the temperatures of the top 13a of the support 13 and the base of the object 3 (or its ferromagnetic base) will remain quite close.

Thus, by observing this, there is a risk that, in certain situations, the temperature of the object 3 does not rise sufficiently, e.g. that a temperature of more than 60° C. cannot be reached, which could be Insufficient for a situation other than keeping the product lukewarm.

It is therefore proposed that: In the heated zone located under the inductor and the object 3 (or its ferromagnetic base), the base of the support 13 also emits radiation and natural thermal convection downwards. Furthermore, this zone of the support will advantageously only be in contact with the temperature sensor 35, while the remainder of the elements of the control and heating unit 20 (apart from 19, 35, 41) are in contact with the ambient air under the support, in particular, in the closed chamber 43.

Since these downward emissions of the support 13 are directly linked to the thermal flux received from the top of the support, it has been chosen to increase the thermal flux dissipated (in this case downwards) by the latter, thus reducing the temperatures of the base of this support 13.

In order to achieve this, the natural thermal convection is transformed into forced thermal convection, via cooling means of the support 13, by forming, on the lower face 13b, a temperature lower than that of the top 13a, at least in the environment of the sensor 35 and during at least part of the magnetic induction heating of the object 3.

The use of the fan(s) 27 may then be appropriate, by adapting their operation (released blowing energy) so as to create a temperature difference between this zone at the base of the support and the object 3 which is of the order of 20° C. to 50° C., and typically 35° C. to 45° C., thus making it possible to achieve a high temperature of the object 3, associated with a sufficiently low temperature of the support 13, typically 40° C. on the support, while it is 80° C. in the container 11.

It remains that this temperature difference established between the object 3 and the support 13 will depend on various parameters, including:

the type of object 3 (material of the container, thermal efficiency, size, presence of absence of a lid),

the type of support 13 (material, thickness, colour, thermal conductivity),

the ambient temperature,

the spacer 7 (thickness, shape, material).

On the other hand, once the desired temperature in the container has been reached, it can remain fixed irrespective of the amount of food material 9 to be kept warm, where this “desired temperature” may be the temperature that the user has selected with the keypad 39 and that the control card 31 has converted into energy to be delivered (power, magnetic field intensity, time, frequency, etc.).

To return briefly to the servo-control chain of the unit 20, it will be noted that the inductor 15 can therefore transmit to the object 3 (its base 5 or its tablet 50), via a magnetic field (arrows 51 in FIG. 5), an energy dependent on the power setpoint addressed by the control card 31, according to the predefined parameters. A thermal flux will thus be generated, including buy convection and thermal radiation towards the top of the support 13. By thermal conduction, it will transmit a portion of the flux to the temperature sensor 35 placed in contact with it, and another portion is dissipated by the above-mentioned forced cooling of the support. The regulation system (30, 31, 35) will require more or less power to the inductor, according to the user-regulated setpoint (keypad 39) and the temperature of the supported detected by the sensor 35.

In this servo-control, we may wish to take account of the influence of the magnetic field on the sensor 35 (see arrows 53 in FIG. 5).

Thus, as already mentioned, it may be of interest that, by receiving the field induced by the inductor 15, the temperature sensor 35 is sensitive to this field, such that the sensor detects a rise in temperature when the inductor 15 is operating.

Indeed, if it is sensitive to the magnetic field, the sensor 35 will heat up in proportion to the intensity of the field generated. In practice, this temperature rise should be of the order of 5° C.

Moreover, to prevent a drift of the servo-control due to the inclusion, by the sensor 35, of rapid temperature variations (e.g. in this range of 5° C.) due to rapid variations in the intensity of the magnetic field, we might choose to limit the energy, such as the power output, if the variation is too fast. This allows us to anticipate a too rapid heating of the object 3 relative to the response time of the support 13, which will typically quite slow.

At this stage of the description, it appears useful to review the specific interest that we can find in the inductor 15 being controlled to deliver its energy (such as its electric power) according to a predetermined input temperature gradient rise in the memory 42.

Indeed, with a support having a relatively high thermal inertia (λ>0.1 W/m·K and thickness of preferably 4 to 40 mm), the use of such a gradient will allow us to solve the problem of an excessive temperature rise in the heat-retaining object, and, more specifically, to provide for temperature rises both for the object 3 and the support 13, such that the first is both sufficient and sufficiently fast, and the second is sufficiently low as to not degrade the integrity of the support.

In particular, with such a maximum gradient of lower than 0.04° C. per second, and preferably a first gradient of lower than 0.04° C. per second, then a second even lower gradient for the 3 to 10 last ° C. before the limiting setpoint, the control card 31, when locked at this low gradient, require the inductor 15 to appropriately limit the energy, and therefore, in particular, the intensity of the induced magnetic field, as shown in FIGS. 6 and 7.

In these figures, the same container was used, containing the same amount of water and with the same initial conditions.

FIG. 6 shows two temperature rise curves, for “conventional” induction heating, at 3200 W of induced power, on a device not provided for heating a chafing-dish by arranging said means of limiting the energy transmitted that limit the magnitude of the induced electromagnetic field to prevent overheating of the support 13, without underheating the object 3.

The curve A1 shows a rise in the temperature viewed by a sensor corresponding to the sensor 35. The gradient is between 0.05° C. and 0.25° C. per second, here 0.16° C./s.

The curve A2 shows the corresponding rise of the water temperature detected via a sensor placed in the water container. It still rises in a manner substantially parallel to the first curve.

FIG. 7 shows two temperature rise curves B1 and B2, for induction heating according to the invention, on a device thus provided for heating a chafing-dish by arranging said means of limiting the energy transmitted, allowing the prevention of overheating of the support 13, without underheating the object 3.

The curve B1 shows a rise in the temperature viewed by a sensor 35. Via the keypad 39, the user has controlled the equivalent of a temperature rise of the water in the container to 44° C., a temperature deemed acceptable by the device, because it corresponds, through the correspondence charts, to a temperature of the sensor 35 of e.g. 25° C., which is lower than the predetermined threshold temperature originally entered in the memory 42, e.g. 35° C., which is itself lower than the degradation temperature of the support 13, e.g. 45° C.

The curve B2 shows the corresponding temperature rise of this water detected via the sensor placed in the water container. It continues to rise faster than the curve B1.

The gradient of the curve B1 is first (portion B11) between 0.015° C. and 0.035° C. per second, here 0.02° C./s, and then, at 4° C. before the temperature limiting setpoint (input in memory 42), switches to a second still lower gradient (portion B12), here 0.006° C./s, before switching to an almost zero gradient (portion B13) at or just before the limiting setpoint, here 44° C.

Thus, compared to a conventional induction heating curve, we note, on the temperature rise curves seen by the sensor 35:

A double gradient rise (B11, B12), and then an almost zero gradient (portion B13) at or just before the limiting setpoint, compared with the single gradient A1;

the sharpest gradient decrease (B11) of at least 20% compared to gradient A1, and even here with a ratio of 1/80 between them (B11/A1).

What is claimed is:

1. A device for heating a heat-retaining object adapted to be heated by magnetic induction and used to itself heat or keep warm a food product, wherein the device comprises:
a spacer interposed between the heat-retaining object and a support, the spacer having a thermal conductivity lower than that of the support, 10 in order to limit the thermal conduction between the heat-retaining object and the support, and,
a control and induction heating unit comprising:
a heating device comprising an inductor located under the support and adapted to create an electromagnetic field around the heat-retaining object,
a temperature sensor located under the support for detecting the temperature of the support,
inductor controlling means connected to the temperature sensor, such that the electromagnetic field is induced according to the temperature detections of the temperature sensor, and,
means to limit the transmitted energy which act on the control means of the inductor in order to limit the magnitude of said electromagnetic field induced when the detected temperature reaches a predetermined threshold lower than a degradation temperature of the support.

2. A device according to claim 1, which further comprises cooling means, which cool the support by establishing a temperature difference between the top and the base of the support, at least in the vicinity of the temperature sensor, during at least a portion of the magnetic induction heating of the heat-retaining object.

3. A device according to claim 2, wherein the means for cooling the support are located under the support, in the vicinity of the control and induction heating unit, in order to further contribute to a thermal regulation of electronic components of the inductor or the inductor controlling means.

4. A device according to claim 2, wherein the cooling means for cooling the support comprise at least one fan.

5. A device according to claim 1, wherein the support is a work surface having a thermal conductivity greater than 0.1 W/m·K, and which is permeable to the magnetic field.

6. A device according to claim 1, wherein the heat-retaining object comprises one of a food container and a heat-retaining block.

7. A device according to claim 1, wherein the spacer comprises a hollow cushion interposed between the heat-retaining object and the support, in contact with both of them.

8. A device according to claim 1, where the temperature sensor is sensitive to the electromagnetic field and receives said electromagnetic field when the inductor operates, such that the temperature sensor detects a temperature rise accordingly.

9. A device for heating a heat-retaining object adapted to be heated by magnetic induction and used to itself heat or keep warm a food product, wherein the device comprises:
a spacer interposed between the heat-retaining object and a support underneath, whereby the spacer has a thermal conductivity (λ) lower than that of the support,
an inductor placed under the support, to create an electromagnetic field around the heat-retaining object, whereby the spacer limits an amount of heat transfer from the heat-retaining object towards the support,
a temperature sensor to detect the temperature of the support during the induction heating,
control means of the inductor such that the electromagnetic field is induced according to the temperature detections of the temperature sensor and a setpoint set by a user of the device, by limiting the magnitude of the electromagnetic field induced when the temperature detected reaches a predetermined threshold lower than a degradation temperature of the support.

10. A device according to claim 9, which further comprises cooling means for cooling the support, at least in the vicinity of the temperature sensor placed under the support, such that the temperature on the lower face of the support is then lower than the temperature of the upper face of the support.

11. A device according to claim 9 which further comprises, under the support and in the vicinity of a power electronics unit functionally connected to the inductor, means for cooling the support which are arranged to further contribute to the thermal regulation of the electronic components of the power electronics unit.

12. A device according to claim 9, which further comprises at least one fan for cooling the support throughout the induction heating of the heat-retaining object.

13. A device according to claim 9, wherein:
the temperature sensor of the support is sensitive to the electromagnetic field and receives said electromagnetic field when the inductor operates, such that the sensor detects a temperature rise accordingly.
said temperature sensor is adapted to detect the temperature of the support so as to deduce a rate of variation of the detected temperatures,
and the magnitude of the induced electromagnetic field is limited by means of limiting the energy transmitted to the inductor when said temperature variation rate is higher than a predetermined threshold.

14. A device according to claim 9, wherein the inductor is controlled to deliver energy according to at least one predetermined temperature rise gradient.

15. A device according to claim 14, where said at least one predetermined temperature rise gradient is lower than 0.04° C. per second, and preferably includes a first gradient of lower than 0.04° C. per second, then a second still lower gradient, for the last 5 to 10° C. prior to reaching said predetermined threshold lower than the degradation temperature of the support.

16. A device according to claim 3, wherein the support is a work surface having a thermal conductivity greater than 0.1 W/m·K, and which is permeable to the magnetic field.

17. A device according to claim 5, wherein the heat-retaining object comprises one of a food container and a heat-retaining block.

18. A device according to claim 5, wherein the spacer comprises a hollow cushion interposed between the heat-retaining object and the support, in contact with both of them.

19. A device according to claim 3, where the temperature sensor is sensitive to the electromagnetic field and receives said electromagnetic field when the inductor operates, such that the temperature sensor detects a temperature rise accordingly.

20. A process for heating a heat-retaining object adapted to be heated by magnetic induction and used to itself heat or keep warm a food product, wherein the process comprises steps whereby:
a spacer is interposed between the heat-retaining object and a support underneath, whereby the spacer has a thermal conductivity (A) lower than that of the support,
an inductor is placed under the support, to create an electromagnetic field around the heat-retaining object, whereby the spacer limits an amount of heat transfer from the heat-retaining object towards the support,
during such induction heating, the temperature of the support is detected by a temperature sensor,
the inductor is controlled such that the electromagnetic field is induced according to the temperature detections of the sensor and a setpoint set by the user, by limiting the magnitude of the electromagnetic field induced when the temperature detected reaches a predetermined threshold lower than a degradation temperature of the support.
